(19) United States
(12) Patent Application Publication
(10) Pub. No.: US 2013/0003982 A1
(43) Pub. Date: Jan. 3, 2013

(54) ELECTRONIC APPARATUS AND OPERATION METHOD THEREOF

(75) Inventors: Kai-Chen Lin, New Taipei City (TW); Rui-Yi Chen, New Taipei City (TW); Jui-Lin Chang, New Taipei City (TW)

(73) Assignee: WISTRON CORP., New Taipei City (TW)

(21) Appl. No.: 13/474,588

(22) Filed: May 17, 2012

(30) Foreign Application Priority Data
Jul. 1, 2011 (TW) TW100123277

(51) Int. Cl. H04R 29/00

(52) U.S. Cl. 381/59

(57) ABSTRACT

The invention provides an electronic apparatus. In one embodiment, the electronic apparatus comprises a hard disk, a speaker, and a processor. The hard disk comprises a vibration protection mechanism which lowers the performance of the hard disk when the vibration protection mechanism is activated. The speaker broadcasts a sound. The processor determines whether a vibration level of the speaker is greater than a threshold level, determines whether data stored in the hard disk is being accessed when the vibration level of the speaker is greater than the threshold level, and lowers a volume of the speaker when the data stored in the hard disk is being accessed and the vibration level of the speaker is greater than the threshold level, thereby preventing the vibration protection mechanism from being activated to maintain the performance of the hard disk.

### CROSS REFERENCE TO RELATED APPLICATIONS

This Application claims priority of Taiwan Patent Application No. 100123277 filed on Jul. 1, 2011, the entirety of which is incorporated by reference herein.

### BACKGROUND OF THE INVENTION

1. Field of the Invention

The invention relates to hard disks, and more particularly to a vibration protection mechanism of hard disks.

2. Description of the Related Art

Ordinarily, a notebook computer is equipped with a hard disk and a speaker. The hard disk is for data storage, and the speaker is used to broadcast an audio signal. The hard disk is prone to damage due to large vibrations. For example, a vibration may cause a magnetic head of a hard disk to collide with disk surfaces of the hard disk to induce damage of the magnetic head and scratching of the disk surfaces. To prevent the hard disk from damage due to vibrations, the hard disk of an ordinary notebook computer is equipped with a gravity sensor (G sensor) to detect the vibration of the hard disk. When the gravity sensor detects that the hard disk is vibrating, a vibration protection mechanism of the hard disk moves the magnetic head of the hard disk from the disk surface to prevent the magnetic head from colliding with the disk surface. Thus, damage of the hard disk due to vibrations is prevented.

Because a notebook computer is a portable device, the volume of the notebook computer has been reduced for user convenience. When the total volume of the notebook computer is reduced, the distance between a speaker and a hard disk of the notebook computer is also shortened. If the speaker generates a sound with a large volume, the sound may induce vibrations to the hard disk, and the vibration protection mechanism may therefore be activated. When the vibration protection mechanism is activated, the disk rotation speed of the hard disk is reduced, such that a data accessing speed of the hard disk is therefore reduced, and the performance of the hard disk is degraded. When the sound generated by the speaker induces huge vibrations to the hard disk, the vibration protection mechanism may also move a magnetic head away from a disk surface of the hard disk, such that the data accessing procedure of the hard disk is interrupted. To prevent the data accessing performance of the hard disk from degrading, a mechanism is required to automatically control the operation of the speaker of the notebook computer.

### BRIEF SUMMARY OF THE INVENTION

The invention provides an electronic apparatus. In one embodiment, the electronic apparatus comprises a hard disk, a speaker, and a processor. The hard disk comprises a vibration protection mechanism which lowers the performance of the hard disk when the vibration protection mechanism is activated. The speaker broadcasts a sound. The processor determines whether a vibration level of the speaker is greater than a threshold level, determines whether data stored in the hard disk is being accessed when the vibration level of the speaker is greater than the threshold level, and lowers a volume of the speaker when the data stored in the hard disk is being accessed and the vibration level of the speaker is greater than the threshold level, thereby preventing the vibration protection mechanism from being activated to maintain the performance of the hard disk.

The invention also provides an operation method of an electronic apparatus. In one embodiment, the electronic apparatus comprises a hard disk, a speaker, and a processor, wherein the hard disk comprises a vibration protection mechanism which lowers the performance of the hard disk when the vibration protection mechanism is activated. First, whether a vibration level of the speaker is greater than a threshold level is determined by the processor. When the vibration level of the speaker is greater than the threshold level, whether data of the hard disk is being accessed is determined by the processor. When the data of the hard disk is being accessed and the vibration level of the speaker is greater than the threshold level, the volume of the speaker is lowered by the processor, thereby preventing the vibration protection mechanism of the hard disk from being activated to maintain the performance of the hard disk.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a block diagram of an electronic apparatus capable of automatically adjusting a volume of a speaker 104 according to the invention;

FIG. 2A is a schematic diagram of detection of a reflection ray from the surface of a speaker when the speaker does not vibrate;

FIG. 2B is a schematic diagram of detection of a reflection ray from the surface of a speaker when the speaker vibrates;

FIG. 3 is a flowchart of a method for adjusting a volume of a speaker according to the invention;

FIG. 4 is a block diagram of another embodiment of an electronic apparatus capable of automatically adjusting a volume of a speaker according to the invention;

FIG. 5 is a flowchart of another embodiment of a method for adjusting a volume of a speaker according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

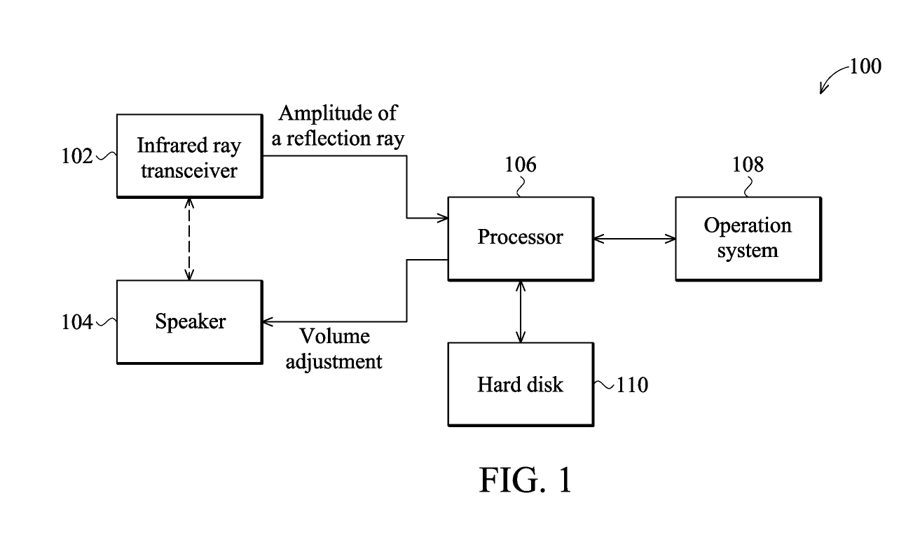

Referring to FIG. 1, a block diagram of an electronic apparatus 100 capable of automatically adjusting a volume of a speaker 104 according to the invention is shown. The electronic apparatus 100 can be a notebook computer. In one embodiment, the electronic apparatus 100 comprises an infrared ray transceiver 102, a speaker 104, a processor 106, an operation system 108, and a hard disk 110. The processor 106 controls other component devices of the electronic apparatus 100. The speaker 104 broadcasts a sound. The hard disk 110 stores data for the processor 106. In one embodiment, the hard disk 110 and the speaker 104 distance from each other. In addition, the hard disk 110 has a vibration protection mechanism to protect the hard disk from damage due to vibrations. For example, when a small vibration is detected, the vibration protection mechanism lowers a disk rotation speed of the hard disk. When a large vibration is detected, the vibration protection mechanism moves a magnetic head away from disk surfaces of the hard disk. Thus, the vibration protection mechanism protects the hard disk from damage due to vibrations.

When a large sound volume generated by the speaker 104 induces the hard disk 110 to vibrate, the vibration protection mechanism is activated. If the disk rotation speed of the hard disk is lowered by the vibration protection mechanism, the data accessing speed of the hard disk 110 is also lowered. If the magnetic head of the hard disk is moved away from the disk surface of the hard disk 110 by the vibration protection mechanism, the data accessing operation of the hard disk 110 is halted. To prevent the vibration protection mechanism from being activated to degrade data accessing performance of the hard disk 110, the electronic apparatus 100 comprises an infrared ray transceiver 102. The infrared ray transceiver 102 is located near to the speaker 104 and projects an infrared ray to the surface of the speaker 104. The infrared ray transceiver 102 then detects an amplitude of a reflection ray of the infrared ray from the surface of the speaker 104. When the speaker 104 broadcasts a sound which causes vibrations, the reflection ray reflected from the surface of the speaker 104 deviates from the infrared ray transceiver 102, and the amplitude of the reflection ray detected by the infrared ray transceiver 102 is reduced. The processor 106 can therefore determine whether the speaker 104 is vibrating according to the amplitude of the reflection ray detected by the infrared ray transceiver 102.

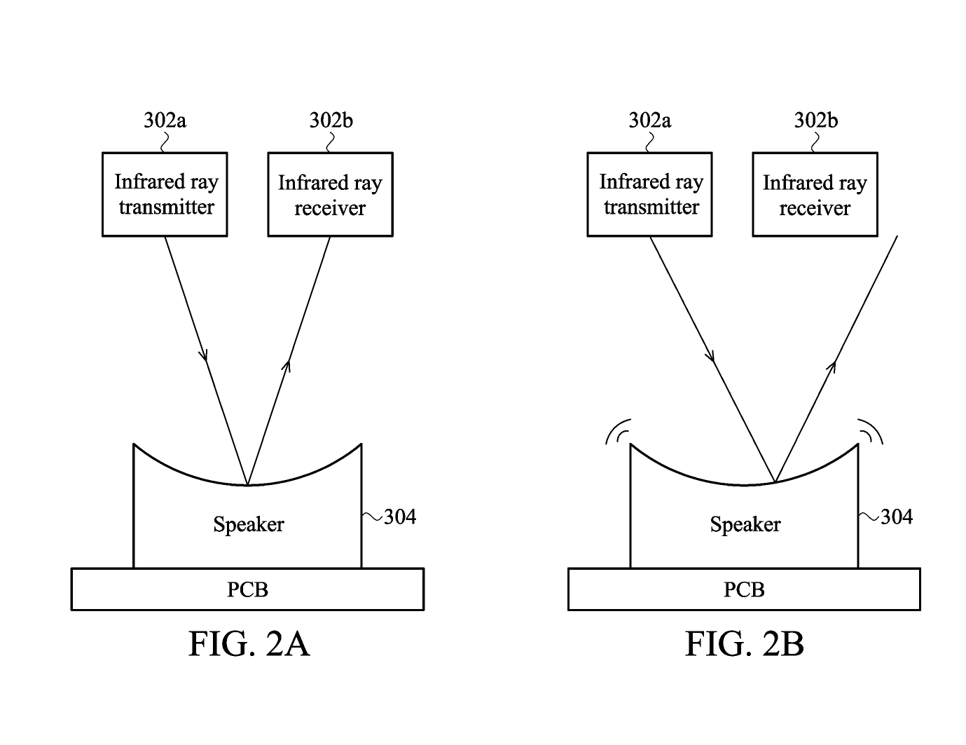

Referring to FIG. 2A, a schematic diagram of detection of a reflection ray from the surface of a speaker 304 when the speaker 304 does not vibrate is shown. An infrared ray transceiver 102 comprises an infrared ray transmitter 302a and an infrared ray receiver 302b. When the speaker 304 does not broadcast a sound and does not vibrate, an infrared ray is projected by the infrared ray transmitter 302a to the surface of the speaker 304, a reflection ray reflected from the surface of the speaker 304 is directly incident to the infrared ray receiver 302b, and the amplitude of the reflection ray detected by the infrared ray receiver 302b is therefore large.

Referring to FIG. 2B, a schematic diagram of detection of a reflection ray from the surface of a speaker 304 when the speaker 304 vibrates is shown. When the speaker 304 broadcasts a sound and vibrates, the reflection ray reflected from the surface of the speaker 304 deviates from the infrared ray receiver 302b, and the amplitude of the reflection ray detected by the infrared ray receiver 302b is therefore small. In one embodiment, the surface of the speaker 304 is curved, and the reflection ray reflected from the curved surface of the speaker 304 deviates from the infrared ray receiver 302b when the speaker 304 vibrates. In one embodiment, the surface of the speaker 304 has a form like fish scales.

The processor 106 receives information about the amplitude of the reflection ray from the surface of the speaker 104 from the infrared ray transceiver 102, and then determines a vibration level of the speaker 104 according to the detected amplitude of the reflection ray. When the detected reflection ray has a small amplitude, the speaker 104 has a high vibration level. When the amplitude of the detected reflection ray is less than a threshold amplitude, the processor 106 determines whether the operation system 108 is accessing data stored in the hard disk 110. When the operation system 108 is accessing data stored in the hard disk 110 and the amplitude of the detected reflection ray is less than the threshold amplitude, the processor 106 lowers the volume of the speaker 104 to reduce the vibration caused by the speaker 104. A vibration protection mechanism of the hard disk 110 is therefore not activated, and the data accessing performance of the hard disk 110 is therefore not degraded by the vibration protection mechanism.

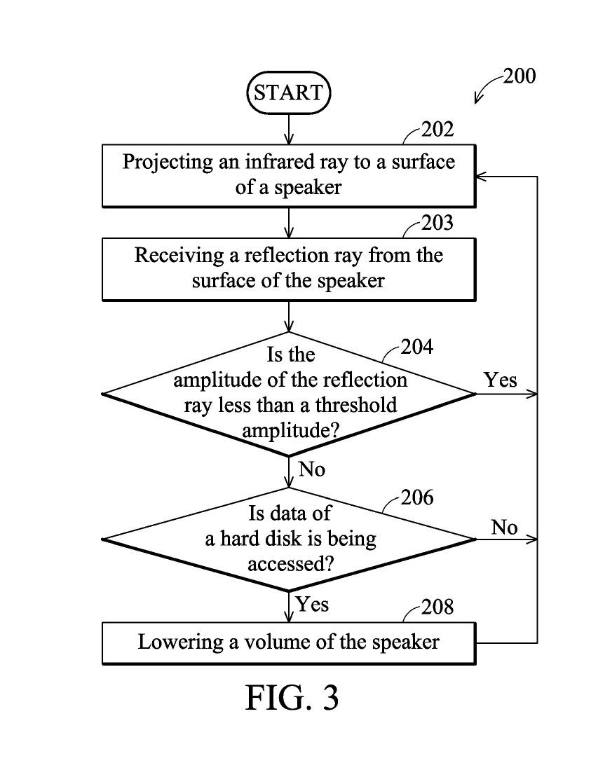

Referring to FIG. 3, a flowchart of a method 200 for adjusting a volume of a speaker according to the invention is shown. First, the infrared ray transceiver 102 projects an infrared ray to the surface of a speaker 104 (step 202). The infrared ray transceiver 102 then detects a reflection ray reflected from the surface of the speaker 104 (step 203), and determines an amplitude of the detected reflection ray. When the amplitude of the detected reflection ray is lower than a threshold value (step 204), the processor 106 determines whether the operation system 108 is accessing data stored in the hard disk 110 (step 206). When the operation system 108 is accessing the data stored in the hard disk 110 and the amplitude of the detected reflection ray is lower than the threshold value, the processor 106 lowers the volume of the speaker 104 to prevent the data accessing performance of the hard disk 110 from being degraded due to vibrations caused by the speaker 104 (step 208). The processor 106 continues to lower the volume of the speaker 104 until the amplitude of the detected reflection ray is greater than the threshold value (step 204). The vibration caused by the speaker 104 is therefore lowered to a level which does not affect the data access operation of the hard disk 110.

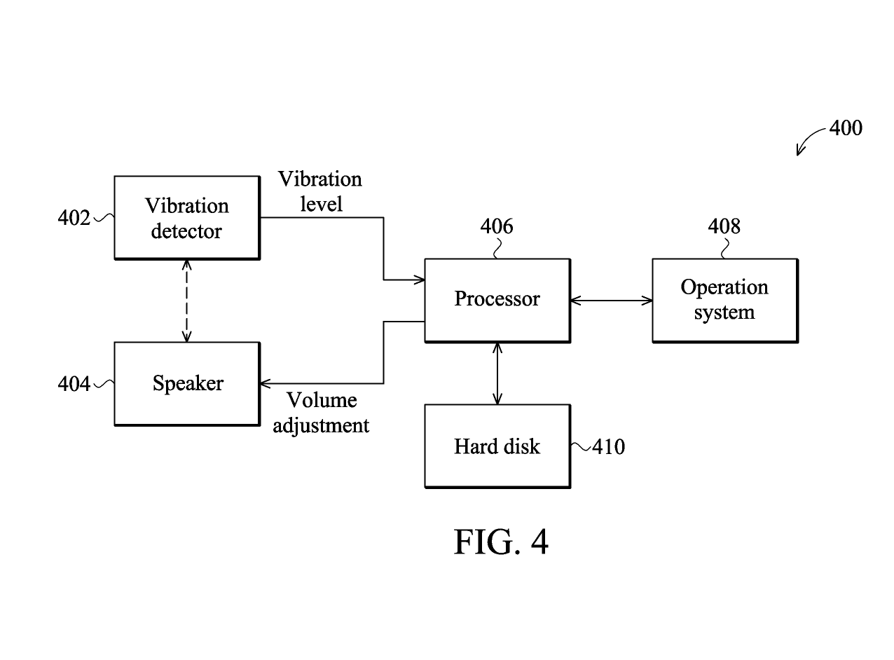

Referring to FIG. 4, a block diagram of another embodiment of an electronic apparatus 400 capable of automatically adjusting a volume of a speaker 404 according to the invention is shown. In one embodiment, the electronic apparatus 400 comprises a vibration detector 402, a speaker 404, a processor 406, an operation system 408, and a hard disk 410. The processor 406 controls other component devices of the electronic apparatus 400. The speaker 404 broadcasts a sound. The hard disk 410 stores data for the processor 406. In one embodiment, the hard disk 410 and the speaker 404 distance from each other. In addition, the hard disk 410 has a vibration protection mechanism to protect the hard disk from damage due to vibrations.

To prevent the vibration protection mechanism from being activated to degrade data accessing performance of the hard disk 410, the electronic apparatus 400 comprises a vibration detector 402. The vibration detector 402 detects a vibration level of the speaker 404. In one embodiment, the vibration detector 402 is a gravity sensor (G sensor). When the speaker 404 broadcasts a sound which causes vibrations, the vibration detector 402 sends the vibration level of the speaker 404 to the processor 406. The processor 406 then determines whether the vibration level of the speaker 404 is greater than a threshold level. When the vibration level of the speaker 404 is greater than the threshold level, the processor 406 determines whether the operation system 408 is accessing data store in the hard disk 410. When the operation system 408 is accessing data stored in the hard disk 410 and the vibration level of the speaker 404 is greater than the threshold level, the processor 406 lowers the volume of the speaker 404 to reduce the vibration caused by the speaker 404. A vibration protection mechanism of the hard disk 410 is therefore not activated, and the data accessing performance of the hard disk 410 is therefore not degraded by the vibration protection mechanism.

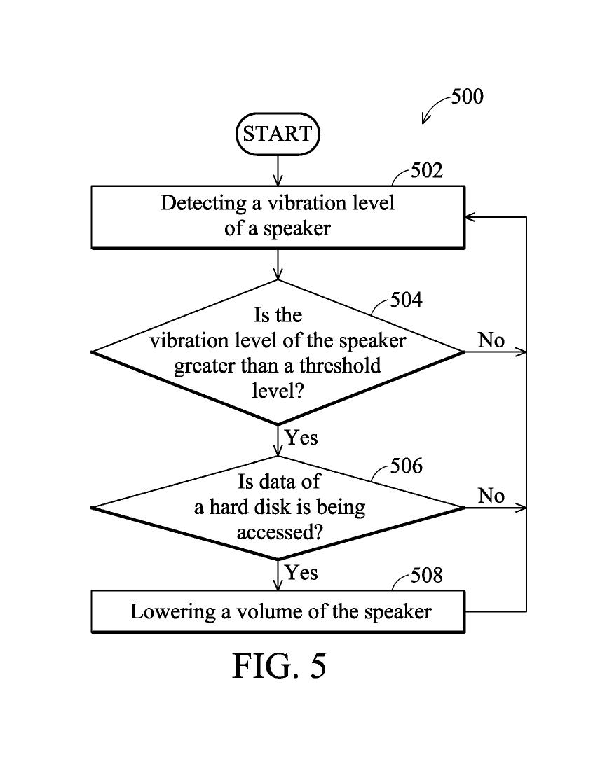

Referring to FIG. 5, a flowchart of another embodiment of a method 500 for adjusting a volume of a speaker according to the invention is shown. First, the vibration detector 402 detects a vibration level of a speaker 404 (step 502). When the vibration level of the speaker 404 is greater than a threshold level (step 504), the processor 406 determines whether the operation system 408 is accessing data stored in the hard disk 410 (step 506). When the operation system 408 is accessing the data stored in the hard disk 410 and the vibration level of the speaker 404 is greater than the threshold level, the processor 406 lowers the volume of the speaker 404 to prevent the data accessing performance of the hard disk 410 from being degraded due to vibrations caused by the speaker 404 (step 508). The processor 406 continues to lower the volume of the speaker 404 until the vibration level of the speaker 404 is less than the threshold level (step 404). The vibration caused by the speaker 404 is therefore lowered to a level which does not affect the data access operation of the hard disk 410.

The invention provides an electronic apparatus capable of automatically adjusting a volume of a speaker. When the volume of the speaker is high and induces vibrations which affect the performance of a hard disk, the electronic apparatus automatically lowers the volume of the speaker. Thus, the data accessing performance of the hard disk is prevented from being degraded.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic apparatus, comprising:
a hard disk, comprising vibration protection mechanism which lowers the performance of the hard disk when the vibration protection mechanism is activated;
a speaker, broadcasting a sound; and
a processor, determining whether a vibration level of the speaker is greater than a threshold level, determining whether data stored in the hard disk is being accessed when the vibration level of the speaker is greater than the threshold level, lowering a volume of the speaker when the data stored in the hard disk is being accessed and the vibration level of the speaker is greater than the threshold level, thereby preventing the vibration protection mechanism from being activated to maintain the performance of the hard disk.

2. The electronic apparatus as claimed in claim 1, wherein the electronic apparatus further comprises:
an infrared ray transceiver, projecting an infrared ray to the surface of the speaker, receiving a reflection ray of the infrared ray from the surface of the speaker, and detecting an amplitude of the reflection ray;
wherein when the amplitude of the reflection ray is lower than a threshold amplitude , the processor determines that the vibration level of the speaker is greater than the threshold level.

3. The electronic apparatus as claimed in claim 2, wherein the surface of the speaker is curved to make the reflection ray reflected from the surface deviate from the infrared ray transceiver when the speaker vibrates, thereby reducing the amplitude of the reflection ray detected by the infrared ray transceiver when the speaker vibrates.

4. The electronic apparatus as claimed in claim 1, wherein the surface of the speaker has a form like fish scales.

5. The electronic apparatus as claimed in claim 1, wherein the electronic apparatus further comprises:
a vibration detector, located on the speaker, detecting the vibration level of the speaker, and sending information about the vibration level of the speaker to the processor.

6. The electronic apparatus as claimed in claim 5, wherein the vibration detector is a gravity sensor (G-sensor).

7. The electronic apparatus as claimed in claim 1, wherein the electronic apparatus is a notebook computer.

8. An operation method of an electronic apparatus, wherein the electronic apparatus comprises a hard disk, a speaker, and a processor, wherein the hard disk comprises a vibration protection mechanism which lowers the performance of the hard disk when the vibration protection mechanism is activated, the operation method comprises:
determining by the processor whether a vibration level of the speaker is greater than a threshold level;
when the vibration level of the speaker is greater than the threshold level, determining by the processor whether data of the hard disk is being accessed;
when the data of the hard disk is being accessed and the vibration level of the speaker is greater than the threshold level, lowering the volume of the speaker by the processor, thereby preventing the vibration protection mechanism of the hard disk from being activated to maintain the performance of the hard disk.

9. The operation method as claimed in claim 8, wherein determining of whether the vibration level of the speaker is greater than the threshold level comprises:
projecting an infrared ray to the surface of the speaker;
receiving a reflection ray of the infrared ray from the surface of the speaker and detecting an amplitude of the reflection ray by an infrared ray transceiver; and
when the amplitude of the reflection ray is lower than a threshold amplitude , determining that the vibration level of the speaker is greater than the threshold level.

10. The operation method as claimed in claim 9, wherein the surface of the speaker is curved to make the reflection ray reflected from the surface deviate from the infrared ray transceiver when the speaker vibrates, thereby reducing the amplitude of the reflection ray detected by the infrared ray transceiver when the speaker vibrates.

11. The operation method as claimed in claim 10, wherein the surface of the speaker has a form like fish scales.

12. The operation method as claimed in claim 8, wherein determining of whether the vibration level of the speaker is greater than the threshold level comprises:
detecting the vibration level of the speaker by a vibration detector located on the speaker; and
sending information about the vibration level of the speaker to the processor.

13. The operation method as claimed in claim 12, wherein the vibration detector is a gravity sensor (G-sensor).

14. The operation method as claimed in claim 8, wherein the electronic apparatus is a notebook computer.
